(19) United States
(12) Patent Application Publication
(10) Pub. No.: US 2006/0090435 A1
(43) Pub. Date: May 4, 2006

(54) Securing and leakage prevention mechanism of filter tube

(75) Inventors: Hsieh Wen-Pin, Keelung City (TW); Huang Chung-Yen, Keelung City (TW); Lin Chih-Kai, Sinjhuang City (TW); Hu Chien-Hsin, Taipei City (TW)

Correspondence Address: DENNISON, SCHULTZ, DOUGHERTY & MACDONALD, 1727 KING STREET, SUITE 105, ALEXANDRIA, VA, 22314, US

(73) Assignee: HANTECH CORPORATION

(21) Appl. No.: 10/976,890

(22) Filed: Nov. 1, 2004

(51) Int. Cl. B01D 46/00

(52) U.S. Cl. 55/502

(57) ABSTRACT

A securing and leakage prevention mechanism of filter tube includes a filter inside, an inlet and an outlet at one end, a separated tube cover on the top, and is fixed with the tube cover by a securing ring. It is characterized in: the bottom edge of tube cover has wrapped portion outward expanding and downward extending to the bottom and connected with the plate rim of tube body, which forms a safety barricade capable of preventing outward protrusion of seal ring. The exterior surface of wrapped portion and the interior surface of securing ring form a joint curve surface, thus substantial securing and fixing and leakage prevention can be achieved.

### BACKGROUND OF THE INVENTION

1. Field of the Invention

The present invention relates to a securing and leakage prevention mechanism of filter tube, and more particularly to a securing and leakage prevention mechanism of filter tube that can effectively prevent leaking of seal ring compressed by tube interior water pressure, which causes water leakage, through changing the shape of bottom plate rim of tube cover.

2. Description of the Prior Art

Generally speaking, percolating water is the most direct and common method to improve water quality in terms of cleanness and hygiene.

As shown in FIG. 1, a conventional water filter tube has a long tube body 1 with an inlet 11 and an outlet 12 at the bottom, and a foot adjustment 13 to prevent touching with ground. One to several filters (not shown in the figure) is installed in the interior of tube body 1, and a tube cover 14 is covered on the top of tube body. Also, a securing ring 15 is used to tight fix tube cover 14 with tube body 1.

However, the structure mentioned above frequently has deficiency during operation. As shown in FIG. 2, an upward protruding inner shell 16 is usually set on the top of tube body. A level lip 17 that turns outward about 90° angles is formed outward over the exterior of tube body near the inner shell top. An O-shaped ring 18 is provided on the top of level lip. Also, a level press plate 19 that turns outward about 90° angles is formed at the bottom of tube cover. During assembling, the level press plate 19 of tube cover is pushed upward and the level lip 17 is pressed down to suppress the O-shaped ring 18 unitedly, then a securing ring 15 is used to wrap and fix the O-shaped ring 18. However; in such a structure, the high pressure of flow inner shell will push and squeeze the O-shaped ring 18 outward through a crack when the pressure of flow inner shell is too high (about 100 P to 150 P). Since level press plate 19, O-shaped ring 18, and level lip 17 are located at different height, despite that the securing ring 15 is provided outside, the deformation of securing ring 15 in contact with level press plate 19, O-shaped ring 18, and level lip 17 may occur; which causes leakage.

Accordingly, the present invention has been made for solving the above-mentioned problems occurred in the prior art.

### SUMMARY OF THE INVENTION

The purpose of the present invention is to provide a securing and leakage prevention mechanism of filter tube. In the securing and leakage prevention mechanism of filter tube according to the present invention, an outward expanding and downward extending wrapped portion is formed at the bottom of tube cover and in contact with the seal ring and tube body, so that the purpose of substantial sealing can be achieved.

In the securing and leakage prevention mechanism of filter tube according to the present invention, the exterior surface of wrapped portion at the bottom of tube cover and the interior surface of securing ring further have the same curve surface to strengthen the function of wrapping and constriction.

In the securing and leakage prevention mechanism of filter tube according to the present invention, the securing ring further has an active hook with a guideway in the middle. A shank in the ring body perpendicular to ring corresponds to the location relative to this guideway. A butterfly-type screw having larger width than said guideway on top of the shank is provides, so that convenient control and use can be achieved.

The detailed structure, application principles, functions and effects of the present invention will become more apparent by describing the preferTed embodiment of the present invention with reference to the attached drawings.

### BRIEF DESCRIPTION OF THE DRAWINGS

FIG. 1 is a three-dimensional view of a conventional filter tube.

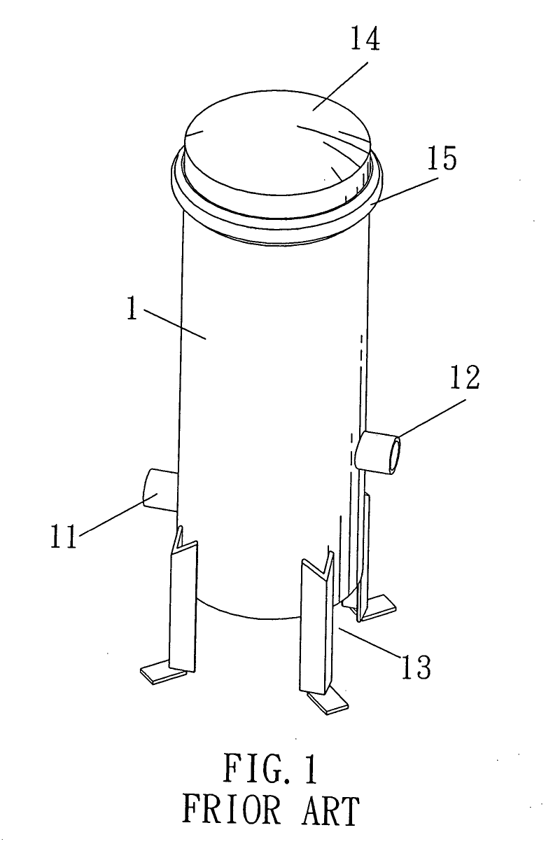

FIG. 2 is a local sectional drawing of a conventional filter tube.

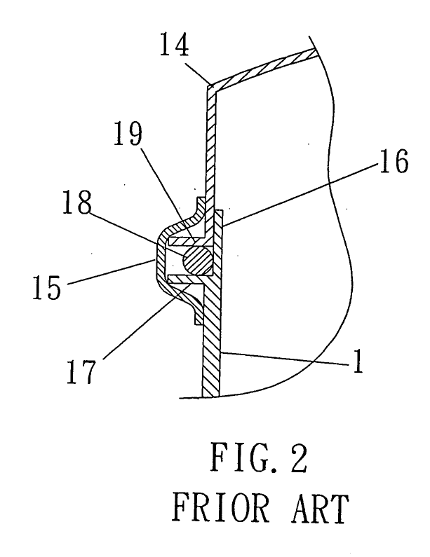

FIG. 3 is a partial leakage view of a conventional filter tube.

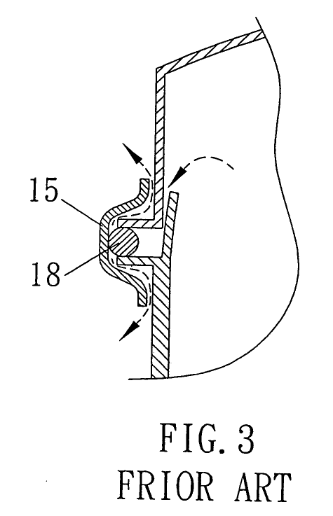

FIG. 4 is a three-dimensional assembly view of filter tube according to the present invention.

FIG. 5 is a three-dimensional decomposition view of filter tube according to the present invention.

FIG. 6 is a partial sectional drawing of filter tube according to the present invention.

FIG. 7 is a partial enlarged view of filter tube according to the present invention.

FIG. 8 is an operation figure of securing ring of filter tube according to the present invention.

FIG. 9 is an unfolded view of securing ring according to the present invention.

### DETAILED DESCRIPTION OF THE PREFERRED EMBODIMENTS

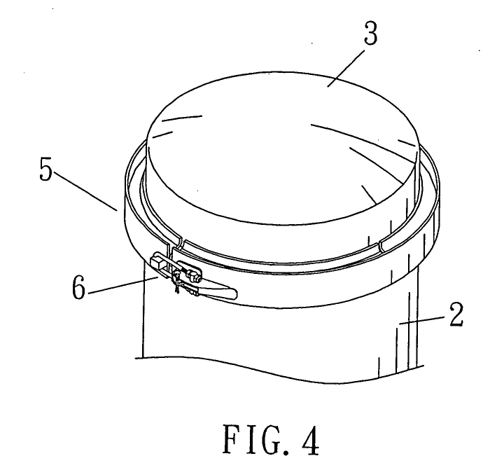

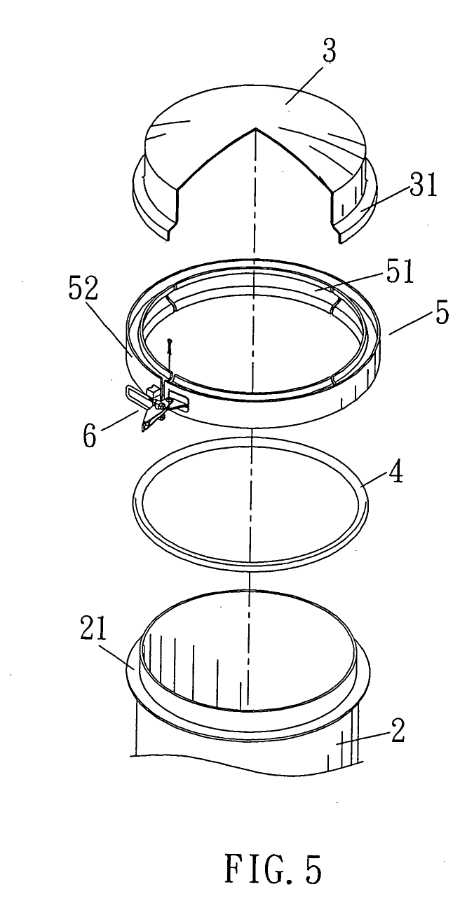

The securing and leakage prevention mechanism of filter tube according to the present invention, as shown in FIGS. 4 and 5, the tube body 2 of the filter tube is a straight tube with frame, inlet and outlet at the bottom. A tube cover 3 is covered on top of tube body and a seal ring 4 is installed on the edge of upper end of tube body 2. Then, a securing ring is used to wrap and constrict in order to sustain higher pressure and prevent leakage.

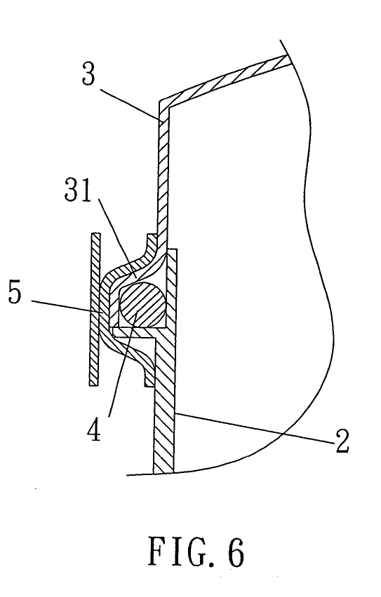

As shown in the figure, the bottom rim of tube cover 3 has an outward expanding and downward extending wrapped portion 31. The wrapped portion may contact with external active lip of tube body periphery and comprises a seal wall to obstruct and warp the seal ring 4 (as shown in FIG. 6). When constricting with a securing ring 5 in the exterior of wrapped portion 31, since the inner surface of securing ring 5 and outer surface of wrapped portion 31 serve as the same curve surface, the securing ring 5 and wrapped portion 31 connect with each other closely, which results in better constriction effect.

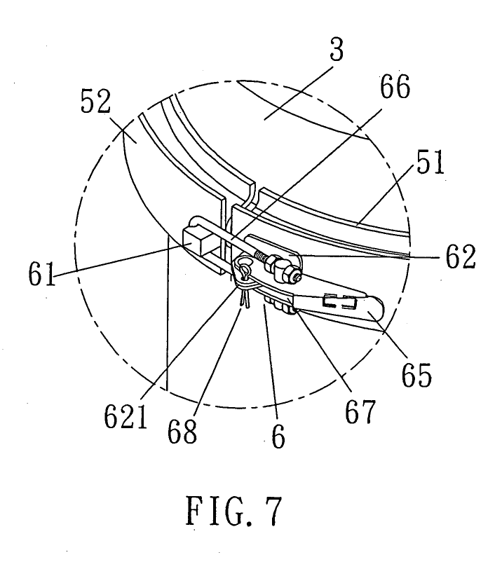

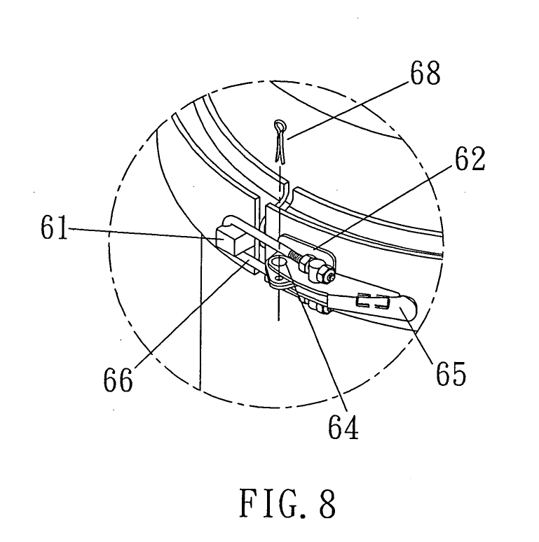

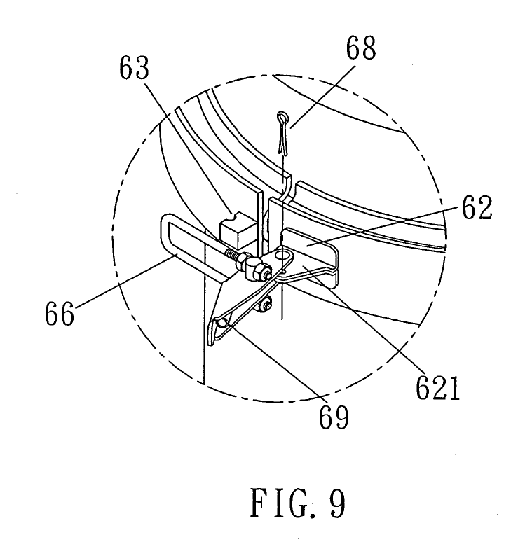

The securing ring, as shown in FIGS. 7, 8, and 9, includes a multi-joint inner ring 51, an outer ring 52 and a padlock 6. The multi-joint inner ring 51 is composed of many joint rings. The joint rings are separated with appropriate distance and have the same curve surface with wrapped portion inner on the top. All joint rings can be connected as a circular shape by outer ring 52. The outer ring 52 is connected to the padlock 6 at one open end. The padlock 6 includes hooks 61 connected with outer ring both open ends and mass 62. A hook slot 63 is deposited on one end of hook 61. A vertical unit 621 is deposited on the top of mass 62. A lockhole 64 is provided on the vertical unit 621 and a hook handle 65 is pivoted thereon. Both sides of hook handle are screwed by a U-shaped hook ring 66 and have a guideway 67 in the middle to move along the surface of vertical unit and can be fixed by a fastener 68 through lockhole 64. Also, a tube 69 is provided in the end of hook handle to allow for a screwdriver plugging in to control the movement.

As shown in figures, by drawing out the fastener 68 and pulling the hook handle open upward, the U-shaped hook ring 66 can be withdrew from hook slot 63, so that the securing ring can be opened, or otherwise closed on the other hand.

As described above, the securing and leakage prevention mechanism of filter tube according to the present invention can actually achieve effective sealing of the seal ring by forming outward-expanding and downward-extending wrapped portion at the bottom of the tube cover. Also, the presence of the securing ring facilitates overall operation, provides more safety, and improves conventional disadvantages. Also, the present invention has not yet opened to public, it is then complied with the conditions of allowable patents.

Although the above-mentioned embodiments of the present invention has been described for illustrative purposes, those skilled in the art will appreciate that various modifications, additions and substitutions are possible, without departing from the scope and spirit of the invention as disclosed in the accompanying claims.

What is claimed is:

1. A securing and leakage prevention mechanism of filter tube, comprising filters inside, an inlet and outlet at one end, a separated tube cover on the top, and a tube cover constricted and fixed with the tube body by a securing ring, characterized in that: the bottom edge of tube cover has wrapped portion that is outward expanding and downward extending to the bottom and connected with the plate rim of tube body, which forms a safety barricade capable of preventing outward protrusion of seal ring when connected with external active lip, so that truly securing and fixing and leakage prevention can be achieved.

2. The securing and leakage prevention mechanism of filter tube as claimed in claim 1, wherein the outer surface of wrapped portion at the bottom of said tube cover and inner surface of securing ring forms a matching, joint curve surface.

3. The securing and leakage prevention mechanism of filter tube as claimed in claim 1, wherein said securing ring includes a multi-joint inner ring, outer ring, and padlock, which has a hook and mass at both open ends of outer ring; a hook slot is provided on one end of said hook and a vertical unit is provided above the mass, and there is a lockhole in vertical unit and a hook handle; both sides of said hook handle are screwed by a U-shaped hook ring, have a guideway in the middle to move along the surface of vertical unit, and can been fixed by a locker through said lockhole.
